(19) United States
(12) Patent Application Publication
(10) Pub. No.: US 2007/0241476 A1
(43) Pub. Date: Oct. 18, 2007

(54) Process for Producing Transparent Articles with Various Emerging Inserts

(76) Inventors: Mario Mottalini, Spezzano Di Fiorano (IT); Diego Mottalini, Spezzano Di Fiorano (IT)

Correspondence Address: LADAS & PARRY, 5670 WILSHIRE BOULEVARD, SUITE 2100, LOS ANGELES, CA, 90036-5679, US

(21) Appl. No.: 11/661,961

(22) PCT Filed: Dec. 23, 2005
(86) PCT No.: PCT/EP05/57168

§ 371 Date: Mar. 1, 2007

(30) Foreign Application Priority Data
Jan. 11, 2005 (IT) MO2005A000001

(51) Int. Cl. B32B 27/00

(52) U.S. Cl. 264/171.1

(57) ABSTRACT

The process enables articles to be produced comprising a transparent solid matrix (16; 16A, 16B) obtained from a liquid material able to solidify. In the transparent matrix (16; 16A, 16B) there being partially incorporated inserts (14) which emerge from a flat surface of these articles. The process comprises the following steps: a) pouring a liquid rubbery material onto a flat working surface (11) bounded by side walls (13) and having the same shape and same dimensions as that surface of the article from which the inserts (14) are to emerge, the height of the layer of rubbery material (12) being at most equal to the amount by which the emerging inserts (14) are required to project; b) depositing the inserts (14) on the rubbery material (12) while still in the liquid state; c) awaiting at least partial hardening of the rubbery material (12) in order to enable the next step to be implemented; d) pouring the liquid incorporating material which is to form the matrix (16; 16A, 16B) such as to completely cover the inserts (14); e) awaiting at least partial hardening of the liquid rubbery material (12) and the liquid incorporating material (16; 16A, 16B) to enable the obtained article to be removed from the working surface (11); f) eliminating the layer of rubbery material (12) from the article by tearing off.

The present invention relates to a process for producing articles comprising a transparent solid matrix in which inserts emerging from a flat surface thereof are partially embedded or incorporated, said articles also being able to comprise other inserts completely incorporated into the matrix. The inserts can be the most various, in particular pebbles, marble or ceramic pieces, shells, pieces of wood, glass items coloured to make them distinguishable within the transparent matrix, and more generally any items suitable for the purpose.

It should be noted that the articles obtained by the process described hereinafter can also have a merely decorative function. An example of this latter case is an ornament obtained by said process.

It is already known to incorporate inserts such as flowers, leaves, pebbles or shells into suitable liquid resins which, when substantially solidified at ambient temperature, result in articles consisting of a transparent solid body incorporating said inserts. To avoid misunderstanding, it should be noted that hereinafter the term “liquid” referred to said resins is to be understood in the sense that that they have a certain viscosity.

The articles obtained by the aforedescribed process are used either self standing or located in a relative seat provided in other articles. From EP 1256462 A2 it is known for example to insert into a through hole provided in a tile a corresponding small tile obtained in the aforedescribed manner and comprising a transparent solid matrix obtained from said liquid resins, and in which various items are completely incorporated such as pebbles, flowers, shells or anything else suitable for the purpose. The final tile can be formed not only from said small tile but from parts of other tiles or polished stone, glued laterally together or to a support to hence obtain the final tile.

A problem which appears in such constructions, especially in the case of flooring tiles, which are subjected to treading, is that the relative surface of the transparent matrix, incorporating said inserts, can become scored with time or in any event worn and consumed, to lose its characteristic surface transparency, and hence assume a poor appearance.

If the items incorporated into the transparent matrix are pebbles of a material of suitable hardness and wear resistance (for example pebbles normally of a specific gravity greater than that of the aforesaid resins in the liquid state used for forming the transparent matrix) and disposed a small distance apart, said problem could be solved by simply making said inserts project at least slightly from the surface of the transparent matrix. In this case the wear would in practice concern only that surface part of these inserts which projects from the transparent matrix, so preserving the remaining part of the relative tile surface consisting of the transparent matrix alone (seeing that this surface is lower). The problem is how to obtain this result.

This problem can be solved by the process of the present invention, this process comprising the following steps:

a) pouring a liquid rubbery material onto a flat working surface bounded by side walls and having the same shape and same dimensions as that surface of the article from which the inserts are to emerge, the layer of liquid rubbery material thus obtained reaching a height which must be less than that of the insert of least height, the height of the layer of rubbery material being at most equal to the amount by which the emerging inserts are required to project;

b) depositing in the required positions on the rubbery material while still in the liquid state the inserts which are to emerge from said surface of the article;

c) awaiting at least partial hardening of the rubbery material in order be able to effect the next step;

d) pouring into the space defined by said side walls the liquid incorporating material which is to give rise to the transparent solid matrix, in a quantity which enables the previously deposited inserts to be completely covered;

e) awaiting at least partial hardening of the liquid rubbery material and liquid incorporating material to enable the obtained article to be removed from the working surface;

f) eliminating the layer of rubbery material from said article by tearing off.

If non-emerging inserts of specific gravity greater than or equal to that of the liquid incorporating material are also to be incorporated into the transparent matrix, an additional step b1) is inserted between steps d) and e), consisting of depositing non-emerging inserts onto the still liquid incorporating material poured in step d), in accordance with the required plan distribution, the liquid incorporating material having to completely cover the non-emerging inserts.

However, if the non-emerging inserts have a specific gravity less than that of the liquid incorporating material, because of which they float thereon, step d) must be divided into two partial pouring steps d₁) and d₂) separated by a step b₁) consisting of depositing the non-emerging inserts on the still liquid incorporating material poured in step d₁) in accordance with the required distribution, followed by a waiting step e₁) to allow the incorporating material poured in step d₁) to at least partially harden, to enable the second partial pouring step d₂) to be implemented and hence completely cover all the inserts.

The temperature at which the aforedescribed process is carried out can be ambient, although higher temperatures can be used to accelerate the hardening of the incorporating material (for example a temperature of 40° C. if using epoxy resins), as is well known to the expert of the art.

With the present invention an article can be obtained which, in addition to inserts emerging from one of its flat surfaces, also presents non-emerging inserts completely incorporated into the transparent matrix.

It is also apparent that by further subdividing the pouring steps d) and d₂), in the case of non-emerging inserts of specific gravity greater than or equal to, and respectively less than, that of the liquid incorporating material, an article of the aforesaid type can be obtained in which the non-emerging inserts lie at different depths within the transparent matrix. In particular, in the first case the pouring step d) is divided into two or more partial pouring steps d₁), d₂), d₃) . . . , between the consecutive partial pouring steps there being respectively inserted a step b₁) of partial deposition of the non-emerging inserts onto the liquid incorporating material poured in the previous partial pouring step, followed by a waiting step e₁) to enable this latter to at least partially harden, to enable the next partial pouring step to be implemented.

In the case of non-emerging inserts of specific gravity less than that of the liquid incorporating material, if these inserts are to be disposed within the matrix at two or more depths, the partial pouring step d₂) is divided respectively into two or more partial pouring substeps d_{2.1}), d_{2.2}), d_{2.3}) . . . , between consecutive partial pouring substeps there being respectively inserted a step b₁) of partial deposition of non-emerging inserts onto the liquid incorporating material poured in the preceding partial pouring substep, followed by a waiting step e₁) to enable this latter to at least partially harden, to enable the next partial pouring substep to be implemented.

The incorporating material which forms the transparent matrix can conveniently consist of an epoxy resin (for example that produced by the Italian company TRIAS CHEM and in particular the resin known by the symbol RP026 with hardeners IPE715, IPE743, and IPE743T, in weight percentages of respectively 25%, 45% and 40% on the resin). As will be apparent to the expert of the art, a polyester resin or acrylic resin with suitable physical-chemical characteristics can also be used, these resins being easily available commercially. All the aforesaid resins can be coloured if desired.

The rubbery material used in the aforedescribed process can conveniently be a silicone rubber, for example that produced by the German company WACKER CHEMIE GMBH, and known by the symbol ELASTOSIL® M4511.

The articles obtained can evidently be other than tiles and the emerging inserts can evidently be other than pebbles.

As already stated, using the method of the present invention, articles can be produced which have not only a specific function (for example a tile or a paperweight) but also a decorative function, or indeed merely a decorative function. For example, a cube can be produced, from one face of which there emerge from the transparent material inserts such as pebbles, shells or other items.

The aforedescribed process can also comprise an additional final step consisting of applying a layer of coloured opaque material, of the desired colour or colours, to all or part of the surface of the obtained article other than that surface from which the emerging inserts emerge (in particular to only that surface opposite the surface from which the inserts emerge). This coloured base layer can be obtained for example by simply painting the relative surface of the article with the required colour or colours. Because of the matrix transparency, on observing the article this coloured base can be seen (it could also be merely white), so giving the article a particular aesthetic effect.

Starting with the articles obtained by the process of the present invention, an expert of the art can easily produce complex articles comprising one or more of said articles. In particular a complex article of cubic form can be produced formed from six square tiles obtained by the process of the present invention, one for each face of the cube. This cube can be obtained by gluing the six tiles together along their edges, to obtain said complex article in the form of a cube having emerging inserts on all its six faces. The six tiles could also be held together, to form said cube, by other means (for example a metal frame).

A cube could easily be produced in which not all the six faces (in particular the resting face) present emerging inserts.

The invention will be more apparent from the ensuing description of a process of the invention for producing tiles, even though articles other than tiles can evidently be produced by the same process. In said description, reference is made to the accompanying drawings, in which:

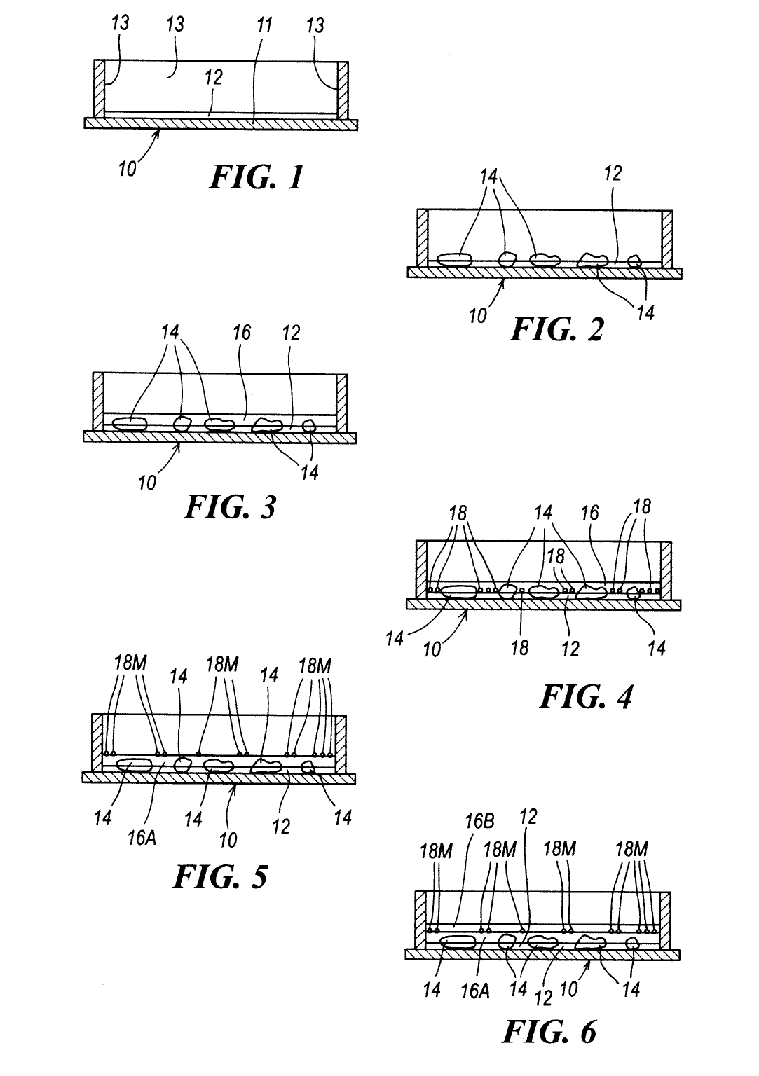

FIGS. 1-3 show some of the most significant steps in the process of the invention, for producing tiles with pebbles emerging from one of the two faces of the transparent matrix;

FIG. 4 shows the most significant step in a variant of the process of the invention, this variant enabling tiles to be produced provided both with pebbles emerging from the transparent matrix and with gravel completely incorporated therein;

FIGS. 5 and 6 show the most significant steps in another variant of the process of the invention, which enables tiles to be produced provided both with pebbles emerging from the transparent matrix and with non-emerging inserts having a specific gravity less than that of the liquid material forming the transparent solid matrix.

To implement the process of the invention, a mould is prepared consisting essentially of a tray 10, shown in vertical cross-section in FIGS. 1-3. The tray 10 has the plan dimensions (for example 15×15 cm) of the tiles to be obtained, and is of suitable depth, not less than the tile thickness (for example 1 cm thickness).

A liquid silicone rubber (for example the aforestated rubber of WACKER CHEMIE GMBH) is then poured onto the base 11 of the mould to form a layer 12 (FIG. 1) of thickness (for example 2 mm) corresponding to the extent of emergence required for said pebbles (in this specific case these latter having a thickness greater than 2 mm, for obvious reasons). This completes step a) of the process. If a different extent of emergence of the pebbles is required, the thickness of the silicone rubber layer 12 must be consequently changed.

To implement the next step b) of the process, the chosen pebbles, indicated in FIG. 2 by 14 (which in this specific case will conveniently be naturally flat or artificially flattened pebbles), are deposited on the still liquid rubber layer 12 in the required distribution, to obtain the situation of FIG. 2. As the pebbles 14 have a specific gravity decidedly greater than the liquid silicone rubber, they sink into it. As flooring tiles are to be produced, the distance between the pebbles must not be excessive, so that in practice the matrix surface is protected from wear.

The silicone rubber layer 12 is now left to attain a sufficient hardness (hence implementing said step c). The time required (which, as already stated, depends on the ambient temperature) is that necessary to enable the next step (d) of the process to be implemented, this consisting essentially of pouring into the space defined by the side walls 13 of the mould 10, above the silicone rubber layer 12 and onto the pebbles 14, liquid epoxy resin (for example the aforestated resin of TRIAS CHEM SRL), even though (as already stated) an expert of the art could opt for a liquid polyester resin or a liquid acrylic resin, of chemical-physical characteristics suitable for the purpose.

As is also well known to the expert of the art, the duration of step e) is also influenced by the temperature at which the process takes place, this duration varying roughly between 60 and 90 minutes. The next step d) enables a layer 16 of said incorporating material to be obtained (FIG. 3) such as to give rise to the transparent solid matrix. The resins used for the purpose could be suitably coloured in a manner well known to the expert of the art. The quantity of incorporating resin forming the layer 16 must be such as to completely cover the pebbles 14 (as shown in FIG. 3).

The incorporating resin forming the layer 16 and the silicone rubber forming the layer 12 are now left to harden sufficiently (step e)) to enable the article hence obtained to be extracted from the mould 10 (again the waiting time is influenced by the temperature at which the process takes place). It should be noted that the duration of step e) is again influenced by the temperature at which the process takes place. The layer 12 of silicone rubber has now merely to be torn away from the article obtained, to obtain the final tile (for simplicity, not shown in the figures).

As already stated, if required, that face of the obtained tile opposite the face from which the pebbles 14 emerge can be painted with the required colour or colours, using suitable paints (for example acrylic paints).

It will now be assumed that tiles are to be obtained which, in addition to said pebbles emerging from a surface of the transparent matrix, also contain gravel incorporated therein. As gravel normally has a specific gravity greater than that of the liquid resins used as incorporating material, after step d) the said step b₁) is implemented, consisting of depositing the gravel 18 in the required plan distribution, this gravel then sinking into the layer of liquid incorporating material 16 (FIG. 4). Said steps e) and f) are now implemented to obtain a tile which in addition to containing emerging pebbles 14 also presents gravel 18 completely incorporated into the transparent matrix.

If the non-emerging inserts (for example wood pieces or leaves) have a specific gravity less than that of the liquid incorporating material used (to distinguish these from those of FIG. 4 they are indicated by 18M), the pouring step d) is divided into two partial pouring steps d₁) and d₂), the step d₁) enabling a partial layer of liquid incorporating material 16A to be obtained, to be immediately followed by a step b₁) in which the additional inserts 18M which float on the layer 16A are deposited (FIG. 5), the step b₁) being followed by a waiting step e₁) to enable the incorporating resin poured in step d₁) to at least partially harden in order to lock the additional inserts 18M in position and enable the second partial pouring step d₂) to take place, this latter enabling the additional inserts 18M to be completely covered by a layer 16B (FIG. 6), this being followed by the waiting step e) and then the step f), to finally obtain a tile which, in addition to the emerging pebbles 14, also presents, completely incorporated into the transparent matrix, inserts 18M of specific gravity less than that of the liquid incorporating material (16; 16A, 16B).

It is considered unnecessary to describe how, by further subdividing the pouring step d) into several partial steps separated by a step of positioning some of the additional inserts followed by a waiting step, it is possible to enable the gravel or other additional inserts, even if of lesser specific gravity than that of the liquid incorporating material, to lie at different depths within the transparent matrix, this being apparent to an expert of the art having read the aforegoing.

For the same reason no description is given of how, using the process of the present invention, articles other than tiles can be obtained, for example paperweights or ornaments, or how complex articles can be produced from the articles obtained.

Said inserts can also be integrated circuits, electric wires, LEDs and the like.

1. A process for producing articles comprising a transparent solid matrix (16; 16A, 16B) obtained from a liquid material able to solidify, there being partially incorporated into the transparent matrix (16; 16A, 16B) inserts (14) which emerge from a flat surface of these articles, the process comprising the following steps:
a) pouring a liquid rubbery material onto a flat working surface (11) bounded by side walls (13) and having the same shape and same dimensions as that surface of the article from which the inserts (14) are to emerge, the layer of liquid rubbery material (12) thus obtained reaching a height which must be less than that of the insert (14) of least height, the height of the layer of rubbery material (12) being at most equal to the amount by which the emerging inserts (14) are required to project;
b) depositing in the required positions on the rubbery material (12), while still in the liquid state, the inserts (14) which are to emerge from said flat surface of the article;
c) awaiting at least partial hardening of the rubbery material (12) in order to enable the next step to be implemented;
d) pouring into the space defined by said side walls (13) the liquid incorporating material which is to give rise to the transparent solid matrix (16; 16A, 16B), in a quantity which enables the previously deposited inserts (14) to be completely covered;
e) awaiting at least partial hardening of the liquid rubbery material (12) and the liquid incorporating material (16; 16A, 16B) to enable the obtained article to be removed from the working surface (11);
f) eliminating the layer of rubbery material (12) from said article by tearing off.

2. A process as claimed in claim 1, wherein, If non-emerging inserts (18) of specific gravity greater than or equal to that of the liquid incorporating material are also to be incorporated into the transparent matrix (16), an additional step b₁) is inserted between steps d) and e), consisting of depositing non-emerging inserts (18) onto the still liquid incorporating material poured in step d), in accordance with the required plan distribution, the liquid incorporating material (16) having to completely cover the non-emerging inserts.

3. A process as claimed in claim 1, wherein if non-emerging inserts (18 M) of specific gravity less than that of the liquid incorporating material (16A) are also to be incorporated into the transparent matrix (16A, 16B), because of which they float thereon, step d) is divided into two partial pouring steps d₁) and d₂) separated by a step b₁) consisting of depositing the non-emerging inserts (18M) on the still liquid incorporating material (16A) poured in the first partial step d₁) in accordance with the required distribution, followed by a waiting step e₁) to allow the incorporating material (16A) poured in step d₁) to at least partially harden, in order to enable the second partial pouring step d₂) to be implemented and hence completely cover (16B) all the inserts (18M).

4. A process as claimed in claim 2, wherein if non-emerging inserts (18) of specific gravity greater than or equal to that of the liquid incorporating material are to be incorporated into the transparent matrix and disposed at two or more different depths within the matrix, the pouring step d) is divided into two or more partial pouring steps respectively, between the consecutive partial pouring steps there being respectively inserted a step b₁) of partial deposition of the non-emerging inserts (18M) onto the liquid incorporating material poured in the previous partial pouring step, followed by a waiting step e₁) to enable this latter to at least partially harden, in order to enable the next partial pouring step to be implemented.

5. A process as claimed in claim 3, wherein if non-emerging inserts (18M) of specific gravity less than that of the liquid incorporating material are to be incorporated into the transparent matrix and disposed at two or more different depths within the matrix, the partial pouring step d₂) is divided respectively into two or more partial pouring substeps, between consecutive partial pouring substeps there being respectively inserted a step b₁) of partial deposition of non-emerging inserts onto the liquid incorporating material poured in the preceding partial pouring substep, followed by a waiting step e₁) to enable this latter to at least partly harden, in order to enable the next partial pouring substep to be implemented.

6. A process as claimed in claim 1, wherein after step f) a further step is added consisting of painting all or part of the surface of the article other than that surface from which the emerging inserts emerge.

7. A process as claimed in claim 1, wherein the liquid rubbery material (12) is a silicone rubber.

8. A process as claimed in claim 1, wherein the liquid incorporating material (16; 16A, 16B) is an epoxy resin, a polyester resin or an acrylic resin.
